(19) United States
(12) Patent Application Publication
(10) Pub. No.: US 2026/0326351 A1
(43) Pub. Date: Oct. 22, 2026

(54) Shaping Tool for Producing a Composite Component

(71) Applicant: BAYERISCHE MOTOREN WERKE AKTIENGESELLSCHAFT, Muenchen (DE)

(72) Inventor: Bernhard SCHMID, Hallbergmoos (DE)

(21) Appl. No.: 19/491,112

(22) PCT Filed: May 7, 2024
(86) PCT No.: PCT/EP2024/062584

§ 371 Date: Dec. 8, 2025

(30) Foreign Application Priority Data
Jun. 13, 2023 (DE) 10 2023 115 372.2

(51) Int. Cl. B29C 45/14; B29L 31/30

(52) U.S. Cl. CPC B29C 45/14065; B29C 45/14688; B29C 45/14811; B29C 2045/14098; B29L 2031/3005

(57) ABSTRACT

A shaping tool for producing a composite component which has a carrier layer, a decorative layer connected to the carrier layer, and a plastic part moulded onto the carrier layer and/or the decorative layer. The shaping tool has an upper tool and a lower tool which form a cavity. A lifting insert is disposed between the upper tool and the lower tool where, when the composite component is disposed in the cavity, the composite component is pressable against the upper tool and/or the lower tool by the lifting insert. The lifting insert is movable such that a gap is settable corresponding to a layer thickness of the composite component that is disposed between the lifting insert and the upper tool and/or the lower tool.

### BACKGROUND AND SUMMARY

The invention relates to a shaping tool for producing a composite component which has a carrier layer, a decorative layer which is connected to the carrier layer and at least one plastics part which is molded onto the carrier layer and/or the decorative layer. The invention further relates to a vehicle part produced using a shaping tool of this type and a vehicle having a vehicle part of this type.

In vehicle construction, carrier elements made of plastics and covered, for example, with fabric or leather as a decorative layer are used as the carrier layer in modern vehicles, in particular in the trim of the interior, such as for example the roof lining, the fittings, the doors, the seats, etc. In addition to visual and haptic considerations, the carrier elements serve primarily for sealing the vehicle interior relative to acoustics, moisture and air permeability. Both for reasons of sustainability and reasons of cost, the need has arisen to replace fossil materials such as plastics at least partially with new, renewable raw materials. The carrier elements, which are not generally visible, are thus increasingly manufactured from natural fiber composite materials, i.e., natural fiber-reinforced plastics as the carrier layer, which have favorable mechanical properties and also result in relatively low production costs. In addition, for example, they are more lightweight than glass fiber-reinforced plastics, they have good acoustic properties and have a low tendency for splintering. Due to the drawback that natural fiber-reinforced plastics often do not meet visual and haptic requirements, however, they are laminated with decorative layers, namely for example fabric, leather but also other textiles, artificial leather, fleece, leather, metal foils, wood veneers, bamboo, flax fabric, for example with PP impregnation, etc.

So-called compression molding is most often used as a production method. So-called injection molding is slightly cheaper and better suited for large quantities. Shaping tools are used during compression molding and also during injection molding. The basic structure thereof is comparable. Typically each shaping tool consists of two halves, namely a static half, in injection molding a so-called nozzle side (lower tool) and a movable opposing ejector side (upper tool). The individual constituent parts of the tool are located in these two halves, namely in injection molding, for example, ejector elements, sprue systems, cores and cavity inserts and cooling or temperature control. A mold cavity in the form of the subsequent workpiece remains between the halves. During compression molding, the molding compound is introduced into the cavity of a die consisting of an upper and lower die. These die halves are then pressed together during the pressing process, so that the molding compound correspondingly adopts the shape of the cavity. The basic structure and sequence of these two methods is sufficiently well known from the prior art.

For example, a method for producing a carrier element is disclosed in DE 10 2013 216 191 B4, in which a polypropylene natural fiber mat with a surface weight of less than 850 g/m² is preheated and inserted into a tool with a rib-shaped cavity. Then the mat is pressed by the tool into the predefined shape, so that the thickness of the mat after pressing is less than 1.2 mm, preferably equal to or less than 0.8 mm. Immediately and directly after the pressing, a material containing polypropylene is “back-injected” into the ridge-shaped cavity of the mat. Due to the back-injection, the material forms stiffening ribs integrally bonded with the mat. Then the mat having the stiffening ribs is demolded. No subsequently visible plastics parts are produced using these methods. This method also has the drawback that the pressing thickness in each case has to be set to a thickness of the mat, since otherwise, for example, with a thicker mat it leads to over-pressing and with a thinner mat to visually unattractive casting burrs.

Different material thicknesses occur since different materials which can have different material properties, such as for example stability, strength, stiffness, weight, density, load-bearing capacity, etc. are used for the carrier layers and decorative layers.

If a material such as, for example, flax fabric, is used as the decorative layer which itself bears the load, i.e., can take on a portion of the load for the carrier layer, naturally the layer thickness of the carrier layer can be smaller, i.e., sometimes half as thick. In decorative layers, the material thereof being purely decorative but bearing little or no load, such as for example TPU foam film, the carrier layer accordingly has to take on virtually the entire load so that the carrier layer is thus sometimes twice as thick. Accordingly, in principle the layer thicknesses of the composite component can differ significantly from one another depending on the choice of material.

The object of the present invention is to provide a device by means of which composite components of variable thickness, i.e., with decorative and carrier layers of different thicknesses, and optionally of a different type, can be pressed using one and the same shaping tool, the injection edges are always sealed and by which a vehicle part manufactured with such a device can be produced more cost-effectively.

According to a first aspect of the invention, a shaping tool is provided for producing a composite component which has a carrier layer, a decorative layer which is connected to the carrier layer and at least one plastics part which is molded onto the carrier layer and/or the decorative layer. The shaping tool has at least one upper tool and at least one lower tool which form a cavity which encloses the composite component, wherein at least one lifting insert which presses the composite component against the upper tool is arranged between the upper tool and the lower tool in order to connect together the carrier layer and the decorative layer and wherein the at least one lifting insert is of movable design in order to set a gap corresponding to a layer thickness of the composite component between the lifting insert and the upper tool and/or lower tool.

Such a shaping tool permits a cost-effective production or manufacture of a vehicle part for a vehicle. Moreover, it provides the possibility of connecting composite components having different layer thicknesses or layer heights and variable compressibility and of molding at least one plastics part without over-pressing the composite component, since the gap between the upper and lower tool before the injection is set exactly to the layer thickness of the composite component. At the same time, the at least one lifting insert cleanly seals an injection edge of the composite component. As a result, the need for overmolding is dispensed with. Moreover, it enables composite components of different thicknesses, i.e., parts with different compositions of the carrier layer and decorative layer, to be pressed with the same shaping tool and at least one plastics part to be molded. A risk to the quality due to different layer thicknesses can also be reduced by the invention when molding the plastics part.

The cavity is the so-called mold cavity which, apart from the decorative layer and the carrier layer, represents a negative impression of the plastics part to be molded. In order to mold the at least one plastics part, the shaping tool naturally comprises, as is usual, an injection molding device of some kind for injecting an injectable molding compound into the cavity of the shaping tool, and a clamping unit for applying a clamping force onto the upper and lower tool of the shaping tool during the injection of the molding compound.

Alternatively or additionally, the at least one lifting insert can press the composite component against the lower tool. For example, the selected carrier layer can be connected or pressed to the selected decorative layer by an integrally bonded connection. Optionally, depending on requirements, an additional material, such as for example adhesive, can be used if an integrally bonded connection would not hold sufficiently well without such an adhesive, for example.

In an advantageous embodiment, the at least one lifting insert is hydraulically and/or mechanically movable.

A hydraulic movement of the lifting insert, for example by means of pistons and cylinders, has the technical advantage that the shaping tool is thus very powerful, relatively little space is required for the lifting insert and generally it also operates with very little wear and thus rarely has to be serviced. In the case of servicing, a mechanically movable lifting insert, such as for example a spindle drive, however, generally can be simpler to service and is also cheaper to repair. Moreover, there is no requirement for fluids which potentially have to be at least monitored and refilled.

In an advantageous embodiment, the shaping tool comprises a control unit which is configured such that it moves the at least one lifting insert before the injection molding process to a specific target lifting value suitable for the layer thickness of the composite component.

As a result, the technical advantage is achieved that each desired layer thickness can be set in advance. Preferably, the control unit can have its own memory from which previously stored layer thicknesses for different specific composite components can be selected. Advantageously, the control unit can also be configured such that it independently recognizes the layer thickness of the inserted composite component and then accordingly sets the target lifting value of the lifting insert. Alternatively, however, the composite component can also be input into the control unit by an operator and the control unit then selects the corresponding layer thickness for the relevant composite component from the memory and sets the corresponding target lifting value which is suitable therefor.

In an advantageous embodiment, the at least one lifting insert is arranged on a rear face of the carrier layer facing away from the decorative layer.

As a result, the technical advantage is achieved that any theoretically possible cosmetic errors can arise only on the rear face of the composite component, which rear face (blind side) is generally not visible during use so that cosmetic imperfections at that point do not have any serious relevance for the customer.

In an advantageous embodiment, the at least one lifting insert bears sealingly against a rear face of the composite component.

As a result, the technical advantage is achieved that the injection edges are always cleanly sealed for the plastics part which is subsequently molded.

Preferably, it can be positioned such that it bears inside a peripheral edge region against the rear face of the composite component.

For the subsequent injection molding process, it thus forms a clear sealing edge for the plastics part of the composite component to be molded, which sealing edge defines the edging or the plastics frame of the plastics part.

In an advantageous embodiment, the at least one lifting insert is mounted in a resilient manner by means of a spring element relative to the upper tool or lower tool.

As a result, the technical advantage is achieved that the target lifting value is set without external intervention, i.e., automatically, in response to a counterpressure due to the layer thickness of the composite component.

Preferably, a spring strength of the spring element can be set such that the lifting insert always presses the composite component with a visible surface of the decorative layer flat against a relevant opposing tool part of the shaping tool. Thus during the injection the visible surface of the decorative layer is sufficiently tightly sealed against an opposing part of the shaping tool such that a visually attractive plastics inner edge is formed.

In an advantageous embodiment, the shaping tool comprises a plurality of lifting inserts which are arranged adjacent to one another and separate from one another. “Adjacent to one another” means that the lifting inserts are arranged in abutment parallel to a visible surface of the composite component or at a spacing from one another. “Separate from one another” means that the lifting inserts are movable or can be set individually or separately.

As a result, the technical advantage is achieved that in composite components with a plurality of portions of different layer thicknesses a gap corresponding to a respective layer thickness between the respective lifting insert and the upper tool and/or lower tool can be set equally in all portions.

According to a further aspect of the invention, a vehicle part produced using a shaping tool of this type is provided. Preferably, a vehicle interior trim part for the vehicle interior of a vehicle can be produced using a shaping tool of this type.

Such a vehicle part is cheaper in terms of production and, as mentioned above, can be manufactured with one and the same shaping tool with different materials without a new shaping tool adapted to a different layer thickness firstly having to be provided or produced therefor.

According to a further aspect of the invention, a vehicle having at least one such vehicle part is provided.

A vehicle with a vehicle part and a shaping tool for producing the vehicle part and further features and advantages are explained in more detail hereinafter by way of an exemplary embodiment which is shown schematically in the figures.

### BRIEF DESCRIPTION OF THE DRAWINGS

FIG. 1 shows a perspective view of the vehicle; and

FIG. 2 shows a side view of the shaping tool.

### DETAILED DESCRIPTION OF THE DRAWINGS

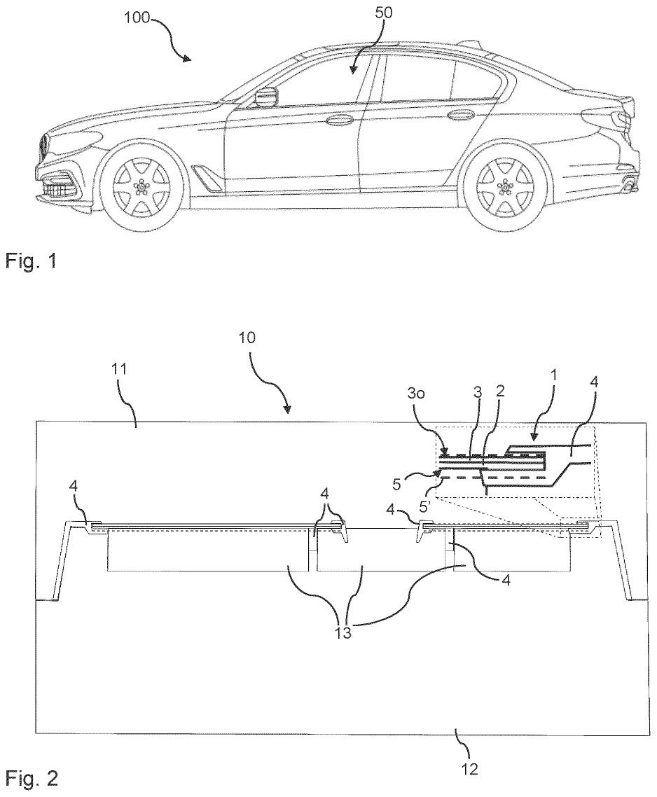

Shown in FIG. 1 is a vehicle 100, here for example a motor vehicle 100, which has in the vehicle interior a vehicle part 50 (not shown) which has been produced by the shaping tool 10 shown in FIG. 2.

As can be seen in FIG. 2, the shaping tool 10 is shown highly simplified and thus limited to the components relevant to the invention. The remaining components (injection molding device, clamping unit, etc.) are sufficiently well known from the prior art to the person skilled in the art, which is why they are only mentioned here if they are relevant for the description of the invention.

The shaping tool 10 has two mold halves, namely an upper tool 11 and a lower tool 12 movable relative thereto (see FIG. 2). In the open, i.e., spaced apart, state (not shown) the constituent parts of the subsequent composite component 1 which are not injected can be inserted between the mold halves 11, 12. In the closed state, shown in FIG. 2, accordingly a cavity is provided between the mold halves 11, 12, which cavity represents a negative impression of the composite component 1 and then in an injection molding step can be filled with a molding compound from an injection molding device (not shown) in order to surround the previously inserted (not injectable) constituent parts of the subsequent composite component 1, amongst other things at the side, optionally all around, with a plastics part 4, namely for example the fork head-shaped plastics frame shown in FIG. 2.

A carrier layer 2 firstly forms part of the components of the composite component 1 which are not injected. The carrier layer 2 is a material layer which is responsible, amongst other things, for the load-bearing capacity of the composite component 1. The carrier layer 2 can accordingly, for example, be a natural fiber composite material, such as for example a natural fiber-reinforced plastics mat or plate, since in addition to other positive properties it has a relatively low weight, low tendency for splintering and good acoustic properties.

Secondly a decorative layer 3 forms part of the composite component 1. The decorative layer 3 fulfills the object of laminating or covering the generally visually unattractive surface of the carrier layer 2. Accordingly, the decorative layer 3 often is simply a thin film, textile, artificial leather, fleece, leather, wood veneer, bamboo or the like. Decorative layers 3 made of such materials are generally not load-bearing and thus have a purely visual purpose (unless they are of particularly thick dimensions, etc. for example). If the decorative layer 3 consists, for example, of a flax fabric with PP impregnation, even with a small thickness it can possibly also take on a part of the load of the carrier layer 2. Thus the carrier layer 2 generally can then be significantly thinner, whereby optionally weight and material costs can be saved.

Due to the different combinations of materials for the carrier layer 2 and the decorative layer 3, (apart from the plastics part 4) very different layer thicknesses can be present for the composite component 1. In order to clarify this, two possible layer thicknesses of the composite component 1 which are clearly different from one another are illustrated in FIG. 2, for example. A composite component 1 with a “thinner” carrier layer 2 is shown by the solid line. The layer thickness of an overall thicker composite component is indicated by the dashed line.

So that the visible surface 30 of the decorative layers 3 of a thicker and a thinner composite component 1, i.e., irrespective of the thickness, is pressed upwardly equally securely, in each case sealed flush against the upper tool 11 (so that amongst other things the thickness of the surrounding plastics part 4 is always of the same thickness above the decorative layer 3 and no sink marks are generated) the shaping tool 10 (as here for example) has at least one lifting insert 13 or tool core 13 (the rectangular plastics parts 4 in FIG. 2 are two domes, i.e., the lifting insert is actually configured continuously around them here) which in the closed state of the mold halves 11, 12 (at a plurality of points equally over its longitudinal extent) presses the composite component 1 upwardly from below by a pressure contact against the rear face 5, 5′ of the carrier layer 2 against the upper tool 11 during the injection of the molding compound.

Depending on how thick the carrier layer and decorative layer 2, 3 are, the lower limb of the edge-side surround in the form of the plastics part 4 of the composite component 1 which is fork head-shaped in cross section—as revealed from the enlarged view in FIG. 2—can be thicker or thinner. The mold halves 11, 12 of the shaping tool 10, however, are configured such that in any case a sufficiently stable lower plastics limb of the plastics part 4 is molded in the injection molding step.

For producing the composite component 1, the carrier layer 2 and the decorative layer 3 are inserted between the mold halves 11, 12 and the movable upper tool 11 is lowered from above onto the static lower tool 12. A target lifting value of the lifting insert 13 is set at the same time or in advance by a control unit. After pressing the carrier layer 2 with the decorative layer 3, molding compound is injected into the mold cavity of the mold halves 11, 12 and the plastics part 4 (amongst other things on the edge side) is molded onto the remaining component, forming the composite component 1. After the curing, the demolding of the composite component 1 from the shaping tool 10 finally takes place.

The shaping tool 10 is characterized by the possibility of manufacturing composite components of different thicknesses, which previously was only possible with a plurality of shaping tools or only with a significant reduction in quality. As a result, the process times can be shortened and possible tolerances can be minimized during the production of composite components, which results in a greater quality of the products. In addition, raw materials and costs for the manufacture of further shaping tools can be saved.

### LIST OF REFERENCE CHARACTERS

1 Composite component
2 Carrier layer
3 Decorative layer
30 Visible surface of decorative layer
4 Plastics part
5 Rear face/blind side of a “thinner” composite component
5′ Rear face/blind side of a “thicker” composite component
10 Shaping tool
11 Upper tool
12 Lower tool
13 Lifting insert/tool core
50 Vehicle part
100 Vehicle

1.-8. (canceled)

9. A shaping tool for producing a composite component which has a carrier layer, a decorative layer connected to the carrier layer, and a plastics part molded onto the carrier layer and/or the decorative layer, comprising:
an upper tool;
a lower tool, wherein the upper tool and the lower tool form a cavity; and
a first lifting insert disposed between the upper tool and the lower tool, wherein when the composite component is disposed in the cavity the composite component is pressable against the upper tool and/or the lower tool by the first lifting insert and wherein the first lifting insert is movable such that a gap is settable corresponding to a layer thickness of the composite component that is disposed between the first lifting insert and the upper tool and/or the lower tool.

10. The shaping tool according to claim 9, wherein the first lifting insert is hydraulically and/or mechanically movable.

11. The shaping tool according to claim 9, wherein the first lifting insert is disposable on a rear face of the carrier layer facing away from the decorative layer.

12. The shaping tool according to claim 9, wherein the first lifting insert is sealingly bearable against a rear face of the composite component.

13. The shaping tool according to claim 9, further comprising a spring element, wherein the first lifting insert is resiliently mounted by the spring element relative to the upper tool or the lower tool and wherein a spring strength of the spring element is settable such that the first lifting insert presses the composite component with a visible surface of the decorative layer flat against the upper tool and/or the lower tool.

14. The shaping tool according to claim 9, further comprising a second lifting insert, wherein the first lifting insert and the second lifting insert are separate from one another and are disposed adjacent to one another.

15. A method for producing a vehicle part, comprising the step of:
producing the vehicle part using the shaping tool according to claim 9.

16. A vehicle, comprising:
a vehicle part produced by the method according to claim 15.
